(19) United States
(12) Patent Application Publication
(10) Pub. No.: US 2020/0055146 A1
(43) Pub. Date: Feb. 20, 2020

(54) PROCESSING METHOD, PROCESSING SYSTEM, AND PROCESSING PROGRAM

(71) Applicant: ROLAND DG CORPORATION, Hamamatsu-shi, Shizuoka (JP)

(72) Inventors: Toshio MAEDA, Hamamatsu-shi (JP); Jun UEDA, Hamamatsu-shi (JP)

(21) Appl. No.: 16/485,835

(22) PCT Filed: Feb. 23, 2018
(86) PCT No.: PCT/JP2018/006651

§ 371 Date: Aug. 14, 2019

(30) Foreign Application Priority Data
Feb. 23, 2017 (JP) 2017-032150

(51) Int. Cl. B23K 26/36; C03C 23/00; B23K 26/55; G05B 19/4093

(52) U.S. Cl. CPC B23K 26/36; C03C 23/0025; G05B 2219/31048; G05B 19/40937; G05B 2219/34105; B23K 26/55

(57) ABSTRACT

A processing method of producing a processed object by processing a material, the processed object including an opening to outside and a hollow space of a predetermined shape and in communication with the opening, includes forming the hollow space in the material by performing ablation by projecting a laser from a region to be processed on a surface of the material corresponding to the opening along a region to be processed corresponding to the hollow space.

### BACKGROUND OF THE INVENTION

### 1. Field of the Invention

The present invention relates to processing methods of producing processed objects including hollow spaces therein, processing systems in which the processing methods are performed, and processing programs that cause the processing methods to be performed.

### 2. Description of the Related Art

Microfluidic devices have wide applications in biotechnological, biochemical, and chemical engineering. Microfluidic devices include ports through which a fluid (such as blood) is fed into the devices, ports through which a fluid is drained to the outside of the devices, and channels connecting these ports. The ports and channels are formed by micro-processing such as laser radiation or etching.

For example, fabrication of ports and channels in microfluidic devices typically involves the formation of bores or grooves in the surface of a material (such as a resin or glass material) by micro-processing, to which another material is bonded.

JP-A-2016-148592 discloses methods of fabricating microfluidic devices in which a laser is directly projected into a glass substrate to reduce the etching resistance; then the region exposed to the laser is subjected to etching to form a channel in the material.

However, conventional methods of fabricating microfluidic devices are complicated because they require two or more different operations such as the formation of a bore or a groove in a material followed by bonding of another material thereto, or the laser projection followed by etching.

This problem becomes more serious with demands for increasing the number of channels in microfluidic devices or increasing the scale of microfluidic devices by, for example, forming multiple ports or multiple channels in a multi-layered structure or fabricating more complicated channels in terms of their shapes.

Such challenges are not restricted to microfluidic devices and it has been difficult to produce processed objects with hollow spaces each having a predetermined shape therein. Although the technique of directly projecting lasers into glass to engrave a figure or the like inside the glass (so-called 3D laser engraving) has been in use, this technique involves creating fine scratches in the glass and thus cannot form a hollow space such as a port or a channel in microfluidic devices.

As a method of solving such problems, a method that involves forming a hollow space directly in the material by performing ablation using a laser can be contemplated. During ablation, the material that has been molten or gasified (converted into a plasma) as a result of the laser projections evaporates and scatters.

With the direct ablation into the material, the molten or gasified material cannot be drained to the outside of the material. Consequently, the molten or gasified material stays in the hollow space formed by the ablation and is deposited there. Such deposition of the molten or gasified material in the hollow space reduces the precision of the processed objects (precision of the hollow spaces). The effects of the molten or gasified material on the precision could cause a significant problem in forming fine hollow spaces such as ports and channels in microfluidic devices.

### SUMMARY OF THE INVENTION

Preferred embodiments of the present invention provide processing methods with which processed objects including hollow spaces therein are able to be produced with high precision, processing systems, and processing programs.

A preferred embodiment of the present invention provides a processing method of producing a processed object by processing a material, the processed object including an opening that is open to outside and a hollow space in communication with the opening, the method including forming the hollow space in the material by performing ablation by projecting a laser from a region to be processed on a surface of the material corresponding to the opening along a region to be processed corresponding to the hollow space.

Other features of preferred embodiments of the present invention are disclosed in the description of this specification.

According to preferred embodiments of the present invention, processed objects including hollow spaces therein are able to be produced with high precision.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic diagram showing a configuration of a processing system according to a preferred embodiment of the present invention.

FIG. 2 is a flowchart showing a method of generating processing data according to a preferred embodiment of the present invention.

FIG. 3A is a diagram showing a processed object in a preferred embodiment of the present invention.

FIG. 3B is a diagram showing a shape data for a processed object according to a preferred embodiment of the present invention.

FIG. 3C is a diagram showing a shape data for a processed object according to a preferred embodiment of the present invention.

FIG. 3D is a diagram showing a divided-surface data according to a preferred embodiment of the present invention.

FIG. 3E is a diagram showing a divided-surface data according to a preferred embodiment of the present invention.

FIG. 4A is a diagram showing a region to be processed in a preferred embodiment of the present invention.

FIG. 4B is a diagram showing a region to be processed in a preferred embodiment of the present invention.

FIG. 5 is a flowchart showing a processing method according to a preferred embodiment of the present invention.

### DETAILED DESCRIPTION OF THE PREFERRED EMBODIMENTS

A processing method according to a preferred embodiment of the present invention is for producing processed objects including an opening and a hollow space by processing a material by laser projections, in which the opening is open to the outside and the hollow space has a predetermined shape and in communication with the opening. The opening is formed in the surface of the material and the hollow space is formed inside the material. The use of lasers makes it possible to process materials in a non-contact manner. Hereinafter, a region where a laser is projected on the surface of or in the material may be referred to as a “region to be processed.”

Materials to be used are those transparent to laser (light transmitting material). Specifically, glass materials or resin materials with high light transmittance (such as acrylic resins) are used. Materials do not require 100% light transmittance and any value will suffice as long as the laser reaches the regions to be processed in the material and processing can be made.

The lasers used preferably are ultrashort laser pulses, for example. Ultrashort laser pulses have a duration ranging from a few femtoseconds to a few picoseconds. By exposing one or more regions to be processed on or in the material to ultrashort laser pulses for a short period of time, ablation (non-thermal processing) is able to be performed. Ablation is a technique of melting or gasifying material by irradiating it with a laser. The material that has been molten or gasified (converted into a plasma) instantaneously evaporates and scatters, thereby being removed; its removal leaves a cavity at the site that was exposed to the laser. With the ablation, damage of each processed site due to heat is lower than that from using typical laser processing (thermal processing). It should be noted that the ablation used in this proposal is a technique of forming, for example, a channel in a microfluidic device by forming voids through inner processing and is technically distinct from thermal processing or other techniques such as 3D laser engraving which creates fine scratches (cracks) in the material.

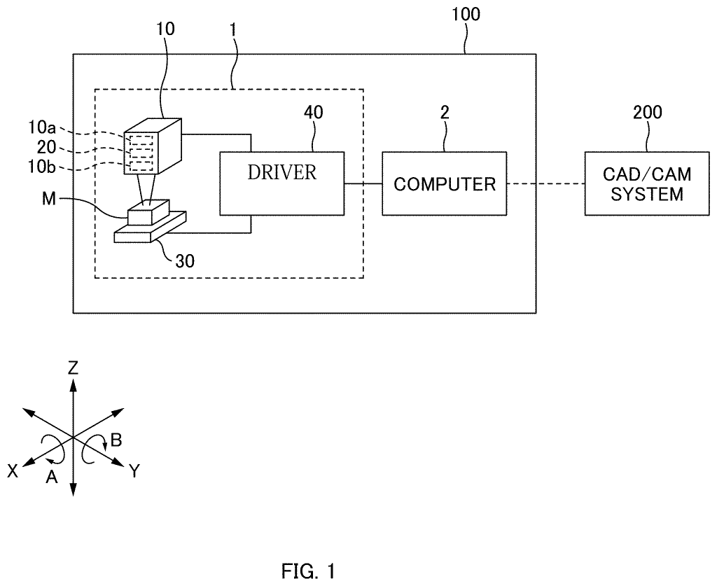

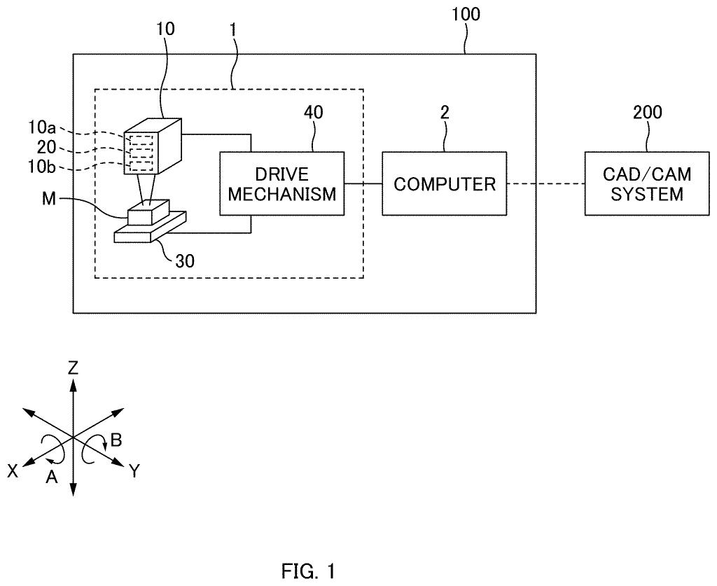

Laser projections onto and into materials are performed based on a processing data (described later) generated in advance. In addition, the processing method according to this preferred embodiment is performed by, for example, a processing system 100 as shown in FIG. 1. The processing system 100 processes materials by executing a processing program produced in a CAD/CAM system 200. Hereinafter, “processing data,” “processing systems,” and “processing by a processing system (processing methods)” are described in detail.

Processing data are used in the processing system 100 in producing processed objects having an opening that is open to the outside and a hollow space in communication with the opening. The processing data are generated in the CAD/CAM system 200.

The processing data according to this preferred embodiment includes at least a projection order data, a surface-of-slice data, and a region-to-be-processed data.

The projection order data defines the order in which the laser projection is performed onto or into the region to be processed. This order is determined by, for example, the shapes of the opening and the hollow space. In order to drain the molten or gasified material to the outside of the material, it is necessary to ensure that the region to be processed to which the laser is projected is in communication with the outside of the material through the opening. That is, internal processing by ablation must be performed bit by bit along the shape of the hollow space starting from the opening. Therefore, the order is determined in such a manner that processing is performed preferentially from the region to be processed corresponding to the opening. As the projection order, it is more preferable to sequentially perform the projection from the region to be processed having a larger cross-sectional area. By processing using the laser projection in order from a wider region to be processed, a wide space for communication with the opening is able to be maintained. In this case, the molten or gasified material is more easily drained to the outside of the material, and as a result, the hollow space contributes to making deposition difficult. Therefore, processed objects are able to be produced with higher precision.

The surface-of-slice data is obtained by slicing a shape data for a material to a certain thickness in a certain direction. A number of (at least two or more) surface-of-slice data are obtained from one shape data. In this preferred embodiment, the slice thickness and slice direction are determined in consideration with absorptivity of the material for the wavelength of the laser, processability of the bores after processing, projection order, projection direction, and processing shape of the laser. Note that the slice thickness and slice direction are preferably set in such a manner that the number of laser projections is as small as possible (in such a manner that the size of a region to be processed in each surface of slice is as large as possible). The reduced number of laser projections provides effects of reducing processing time and reducing or minimizing changes in character of material due to heat.

The region-to-be-processed data is extracted in each of the number of surface-of-slice data. The region-to-be-processed data is used to specify a region to be processed (a data corresponding to the region to be processed). Two or more region-to-be-processed data are extracted depending on the number of the surface-of-slice data but there may be one or more surface-of-slice data containing no region-to-be-processed data depending on the shape of the region to be processed, slice thickness, slice direction, and the like.

Furthermore, one surface-of-slice data may be obtained as divided-surface data that are divided. In this case, the region-to-be-processed data is extracted for each of the divided-surface data that are divided. One surface-of-slice data can be divided into any number of divided-surface data. For example, it may be divided into a predetermined number of divided-surface data defined for each CAD/CAM system 200. Alternatively, the CAD/CAM system 200 may set an appropriate number based on, for example, the shape of the processed object or the shape of the hollow space formed inside. In addition, an operator can freely set a certain number using the CAD/CAM system 200 every time.

The processing data may include a projection pattern data. The projection pattern data is used to determine the direction of projecting a laser onto or into the region to be processed (details of the projection pattern are described later). As to the projection pattern data, a single data may be set for certain processing data, or different projection pattern data may be set for different surface-of-slice data, region-to-be-processed data, or divided-surface data. Note that for each processing system 100, the performance of the equipped laser and the configuration of the adjuster 20 are determined. Accordingly, even when the CAD/CAM system 200 sets a projection pattern, it cannot be performed in some cases. Therefore, the projection pattern may be set in the processing system 100 rather than being included in the processing data.

The processing data may include information about laser output other than projection patterns (e.g., the projection speed and the projection time per unit time of the laser, and laser intensity) or information about the processing precision, information about wall treatment after processing (finishing; mirror finishing and surface modification).

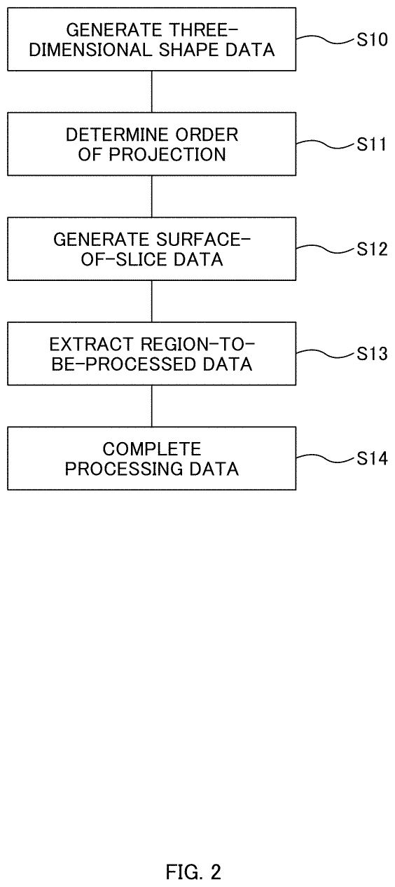

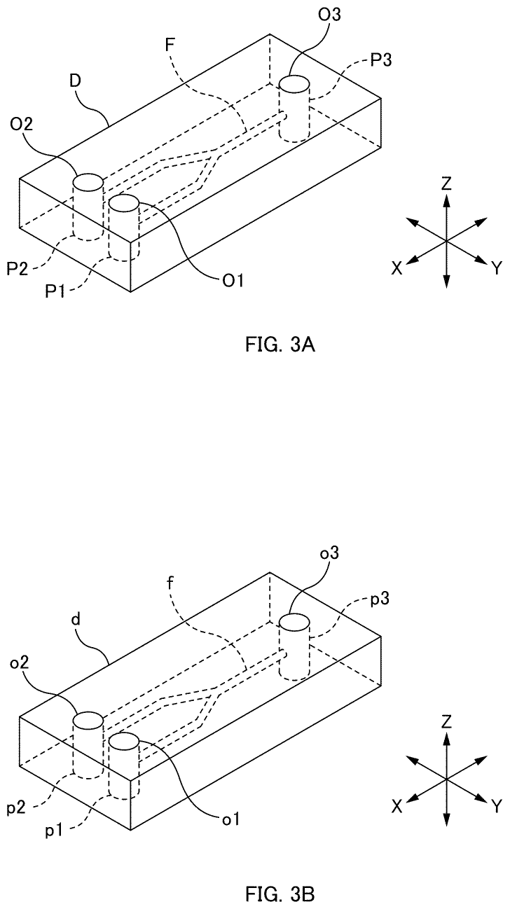

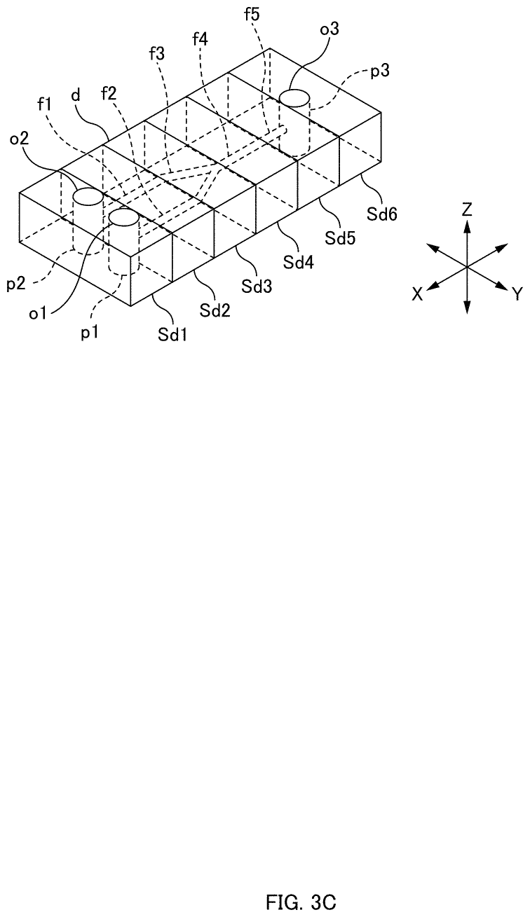

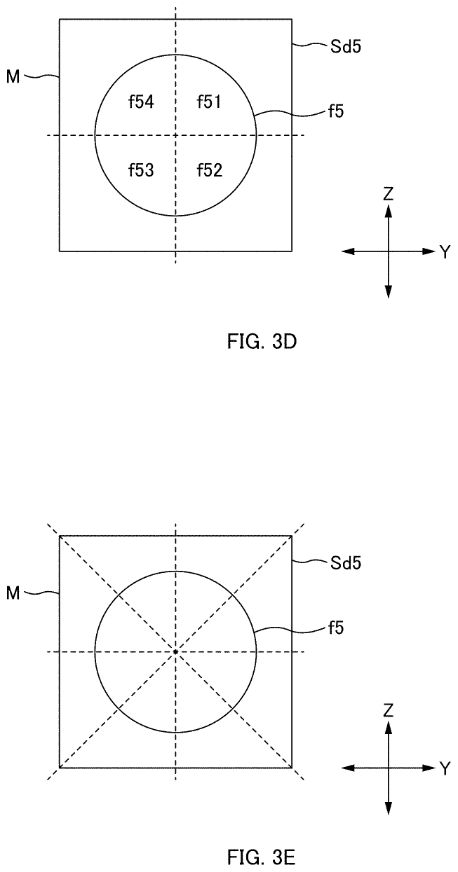

Referring to FIGS. 2 to 3E, a method of generating processing data according to the present preferred embodiment is described. FIG. 2 is a flowchart showing a method of generating processing data. Here, an example of generating a processing data for processing a microfluidic device D (an example of a “processed object”) having a bifurcated channel portion F is described. In FIGS. 2 to 3E, let the lengthwise, widthwise, and height directions of the microfluidic device D (or three-dimensional shape data d) be x, y, and z-directions, respectively.

As shown in FIG. 3A, the microfluidic device D includes three openings O1 to O3, ports P1 to P3, and a bifurcated channel portion F.

The openings O1 to O3 are open to the outside on the surface of the material. The ports P1 to P3 are cylindrical hollows (which are closed at the bottom) extending in the z-direction and communicating with the openings O1 to O3, respectively. The channel portion F is a bifurcated, cylindrical hollow connecting the ports P1 and P3 and the ports P2 and P3. The ports P1 to P3 and the channel portion F are examples of the “hollow space.”

The CAD/CAM system 200 possesses, in advance, a shape data for a material from which the microfluidic device D is fabricated and data defining the shape of the openings and the hollow spaces (x, y, and z-coordinates, shape, diameter, and others of the openings, ports, and channels). These data may be generated in, for example, the CAD/CAM system 200 or data generated in another computer may be transferred to the CAD/CAM system 200.

First, the CAD/CAM system 200 generates a three-dimensional shape data d for a microfluidic device D based on the shape data for the material and the data defining the shapes of the openings and the hollow spaces (a three-dimensional CAD model; e.g., STL data or solid data) (generate three-dimensional shape data; S10). The three-dimensional shape data d includes a region-to-be-processed data corresponding to the openings and the hollow spaces. In this example, the region-to-be-processed data includes region-to-be-processed data o1 to o3 corresponding to the openings O1 to O3, region-to-be-processed data p1 to p3 corresponding to the ports P1 to P3, and a region-to-be-processed data f corresponding to the channel portion F (see FIG. 3B).

The CAD/CAM system 200 determines the order in which the laser is to be projected (determine order of projection; step 11). For example, the CAD/CAM system 200 determines the order of projection in such a manner that the regions to be processed corresponding to the openings are processed preferentially based on the region-to-be-processed data included in the three-dimensional shape data d generated at S10. In this example, it is assumed that the order is determined as follows: (1) the openings O1 to O3, (2) the ports P1 to P3, and (3) the channel portion F (in the direction from the side of the ports P1 and P2 to the side of the port P3). The CAD/CAM system 200 stores the determined order as a projection order data.

The CAD/CAM system 200 generates a number of surface-of-slice data obtained by slicing the three-dimensional shape data d that has been generated at S10 to a certain thickness in a certain direction in consideration of the order determined at S11 (generate surface-of-slice data; S12). The CAD/CAM system 200 sets the slice thickness and slice direction to facilitate the processing in the order determined at S11. The CAD/CAM system 200 can obtain a number of surface-of-slice data by slicing the three-dimensional shape data d based on the set thickness and direction. FIG. 3C shows a state in which a number of surface-of-slice data Sd1 to Sd6 are generated for the three-dimensional shape data d for the microfluidic device D. These surface-of-slice data correspond to surfaces of slice obtained by slicing the microfluidic device D along the YZ-plane.

The CAD/CAM system 200 extracts the region-to-be-processed data in each of the surface-of-slice data (extract region-to-be-processed data; S13). For example, in the example shown in FIG. 3C, the CAD/CAM system 200 extracts the region-to-be-processed data o1, o2, p1, and p2 corresponding to the openings O1 and O2 and the ports P1 and P2 in the surface-of-slice data Sd1, extracts the region-to-be-processed data o3 and p3 corresponding to the opening O3 and the port P3 in the surface-of-slice data Sd6, and extracts the region-to-be-processed data f1 to f5 corresponding to the channel portion F in the surface-of-slice data Sd2 to Sd5 (in this example, the region-to-be-processed data f corresponding to the channel portion F is divided into five, according to the number of the surface-of-slice data).

By performing the above-mentioned processing, the CAD/CAM system 200 is able to generate a processing data including the projection order data determined at S11, the number of surface-of-slice data generated at S12, and the region-to-be-processed data extracted at S13 (complete processing data; step 14).

The CAD/CAM system 200 outputs the generated processing data to the processing system 100. The processing system 100 performs processing of the material by projecting a laser onto or into the region to be processed in the determined order, based on the processing data. The output data may be in any format as long as the data can be used in the processing system 100.

Note that the CAD/CAM system 200 can divide the surface-of-slice data generated at S12 into a number of divided-surface data. For example, the CAD/CAM system 200 can divide the surface-of-slice data Sd5 shown in FIG. 3B into a predetermined number of divided-surface data.

Different patterns of division can be made for the surface-of-slice data. FIGS. 3D and 3E are diagrams showing the surface-of-slice data Sd5 seen from the x-direction. The surface-of-slice data Sd5 includes the region-to-be-processed data f5.

For example, as shown in FIG. 3D, the surface-of-slice data Sd5 can be divided into four blocks like a lattice. Alternatively, as shown in FIG. 3E, the surface-of-slice data Sd5 can be divided into eight blocks radially. Note that one surface of slice can be divided into any number of blocks and each block has any surface area; provided that the surface area of the region to be processed included in each of the divided surface-of-slice data is preferably in a range where a projection unit 10 can project the laser through a single operation.

When one surface-of-slice data is divided into a number of divided-surface data as described above, the CAD/CAM system 200 extracts the region-to-be-processed data for each divided-surface data. For example, in the example shown in FIG. 3D, the CAD/CAM system 200 extracts region-to-be-processed data f51 to f54 for each divided-surface data included in the surface-of-slice data Sd5 (see FIG. 3D).

FIG. 1 is a diagram schematically showing the processing system 100. The processing system 100 produces a processed object with an opening that is open to the outside and a hollow space having a predetermined shape and in communication with the opening by processing a material using a laser. The processing system 100 includes a processor 1 and a computer 2. The processing system 100, however, may include a processor 1 alone when the functions of the computer 2 are integrated into the processor 1.

The processor 1 according to this preferred embodiment includes five driving axes (the x-, y-, and z-axes as well as the A-rotation axis (the rotation axis around the x-axis) and a B-rotation axis (the rotation axis around the y-axis)). The processor 1 performs ablation to the surface of a material M or in the material M by projecting a laser onto and into the material M based on a processing data. The processor 1 is configured or programmed to include the projector 10, the adjuster 20, a holding unit 30, and a driver 40.

The projector 10 projects lasers to the material M. The projector 10 includes a laser oscillator 10a and a group of lenses 10b or others to concentrate the laser light from the oscillator 10a on the material M. The laser oscillator 10a may be provided outside the processor 1.

The adjuster 20 adjusts laser projection patterns. The adjuster 20 may be a galvanometer mirror, a Fresnel lens, a diffractive optical element (DOE), or a spatial light phase modulator (LCOS-SLM). The adjuster 20 is disposed, for example, between the oscillator 10a and the group of lenses 10b in the projector 10. Projection patterns that can be used by a certain processor are determined depending on the configuration of the adjuster 20 of each device.

Now, a specific example of the projection pattern is described.

For example, a pattern in which lasers are projected simultaneously onto each surface of slice (for each region to be processed included in that surface of slice) can be achieved by using a spatial light phase modulator as the adjuster 20. Spatial light phase modulators can shape the laser produced by the oscillator 10a into a desired pattern by adjusting the liquid crystal orientation. For example, a spatial light phase modulator shapes a linear laser beam into a planar pattern and then specifies a certain thickness, allowing the projection of the laser into a thin box shape (a laser with a three-dimensional shape). Using such a spatial light phase modulator, for example, ablation can be performed by just a single laser projection onto the entire region to be processed included in a single surface of slice. That is, by using the spatial light phase modulator, a wider region to be processed is able to be processed simultaneously, leading to reduced processing time. Furthermore, the spatial light phase modulator is able to shape laser beams into various patterns (dot, line, etc.) by adjusting the liquid crystal orientation even when the region to be processed has an intricate shape (e.g., the interface of the region to be processed has a wavy shape). Note that the adjuster 20 may not be a spatial light phase modulator as long as the above-mentioned projection patterns are able to be achieved. For example, a MEMS mirror can be used as the adjuster 20 to apply a laser in a planar pattern.

On the other hand, it may be difficult to project lasers simultaneously depending on a range of the region to be processed. In such cases, the laser can be projected in a projection pattern that lasers are projected to each of different regions in the region to be processed in a certain surface of slice, such that the lasers are projected to each of the different regions at an equal energy density. The energy density is an amount of energy per unit area.

For such projection patterns, the following two patterns (first and second projection patterns) are available as an example. The first and second projection patterns are examples of “predetermined projection patterns.”

First, the first projection pattern is described. The first projection pattern is used to project lasers to each of the divided region to be processed. For example, in the processing data, it is assumed that the divided-surface data as shown in FIG. 3D is included. In this case, the adjuster 20 adjusts the projection pattern in such a manner that the lasers are projected to each of the regions to be processed corresponding to the region-to-be-processed data f51 to f54.

In the first projection pattern, the lasers projected to the regions to be processed have an equal or substantially equal energy density. The energy densities can be equalized by changing the output values for (intensity of) the projected lasers based on the surface areas of the regions to be processed. Alternatively, the energy densities of the lasers projected to the regions to be processed can be equalized without changing the output values for (intensity of) the lasers by performing the division, in generating the divided-surface data, in such a manner that the regions to be processed included in each divided surface have an equal surface area.

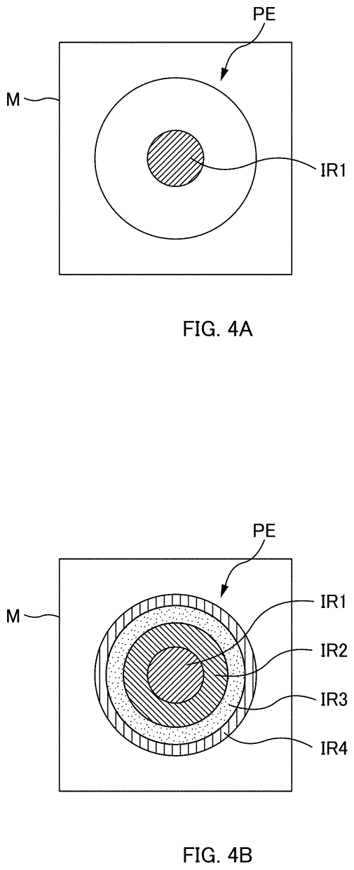

Next, referring to FIGS. 4A and 4B, the second projection pattern is described. FIGS. 4A and 4B are diagrams showing a region to be processed PE in a certain surface of slice of the material M.

The second projection pattern is used to project lasers two or more times to a single region to be processed while changing laser projection regions (so that the projection regions do not overlap). For example, in the second projection pattern, a laser with a certain spot diameter is projected first to the center of the region to be processed PE (see FIG. 4A; the region to be processed that has been subjected to the first laser projection is denoted as a projection region IR1). Next, two or more projections of ring-shaped lasers are performed to the region to be processed PE outward from the outer periphery of the projection region IR1. For example, the region to be processed that has been subjected to the second laser projection (the ring-shaped region outside the projection region IR1) is denoted as a projection region IR2 in FIG. 4B. The region to be processed that has been subjected to the third laser projection (the ring-shaped region outside the projection region IR2) is denoted as a projection region IR3. The region to be processed that has been subjected to the fourth laser projection (the ring-shaped region outside the projection region IR3) is denoted as a projection region IR4. For the laser projection into a ring shape, shapes similar to ring-shaped light guides can be formed by using, for example, a rotary body and an optical system used in helical drilling as the adjuster 20.

In the second projection pattern, the energy densities in the projection regions are equal or substantially equal to each other. For example, the energy densities are able to be equalized by adjusting the range of laser projection in such a manner that the projection regions IR1 to IR4 all have an equal surface area.

In addition, as another projection pattern, a pattern in which a laser is projected to a region to be processed while being scanned in a certain direction can also be used.

This can be achieved by using a galvanometer mirror as the adjuster 20. Galvanometer mirrors include two mirrors and lasers produced by the oscillator 10a can be scanned over XY-planes by driving each mirror independently. Galvanometer mirrors allow fast scanning, leading to reduced processing time.

Optical systems such as Fresnel lenses and diffractive optical elements can adjust lasers in such a manner that a laser has two or more focal points (multifocal) in a direction parallel or perpendicular to its optical axis. By using one of these optical systems as the adjuster 20, processing can be performed for a certain region in a direction of the width (x- and y-directions in FIG. 3C) or the thickness (z-direction in FIG. 3C) of the region to be processed by a single projection. Furthermore, by using a galvanometer mirror in combination with a Fresnel lens or a diffraction grating, it is possible to scan lasers over a wider range.

The holder 30 holds the material M. Any method can be used to hold the material M as long as the material M being held is able to be moved along and rotated around one of the five axes.

The driver 40 moves the projector 10 (the adjuster 20) and the holder 30 relative to each other. The driver 40 includes a servo motor to drive the projector 10 (the adjuster 20) and the holder relative to each other, and other components.

The computer 2 controls operations of various structures of the processor 1. For example, the computer 2 controls the driver 40 to adjust the relative position of the projector 10 and the holder 30 (the material M held by the holder 30) in such a manner that the focal point of the laser comes to the region to be processed. Then, the computer 2 controls the projector 10 and projects the laser onto each region to be processed.

In this preferred embodiment, the computer 2 controls the projector 10 and the driver 40 in such a manner that they perform ablation by projecting lasers along the regions to be processed in the material (corresponding to the hollow spaces) from the regions to be processed on the surface of the material (corresponding to the openings) based on the processing data to form the openings and the hollow spaces. In addition, the computer 2 can control the adjuster 20 in such a manner that the lasers are projected in a certain projection pattern for each of the regions to be processed.

Furthermore, the computer 2 may control the projector 10 and adjust, for example, the intensity and projection time of the laser. The intensity and projection time of the laser affect the power (energy) of the projected laser. These parameters may be included in the processing data in advance as described above or may be set by the processor 1. Furthermore, to determine these parameters, the type and properties of the material to be processed can also be taken into consideration. The computer 2 is an example of the “controller.”

The processing system 100 does not necessarily have five axes as long as a processing method described later can be performed. For example, a processor with three axes, i.e., a driving axis for driving the projector 10 in the z-direction and driving axes for driving the holder 30 in the x- and y-directions, can also be used. In addition, the adjuster 20 is not an essential component for the purpose of processing a processed object having an opening and a hollow space. When no adjuster 20 is provided, the laser is projected onto or into the region to be processed as a point because the laser from the projector 10 is directed via unifocal projection. Processing of the region to be processed with a point (a group of points) in the manner just mentioned requires a longer processing time than when using the adjuster 20, but more detailed processing can be performed. Alternatively, in the processing system 100 including the adjuster 20, it is possible to roughly process the region to be processed by projecting a laser using the adjuster 20, and then to finish it by projecting a laser without passing through the adjuster 20.

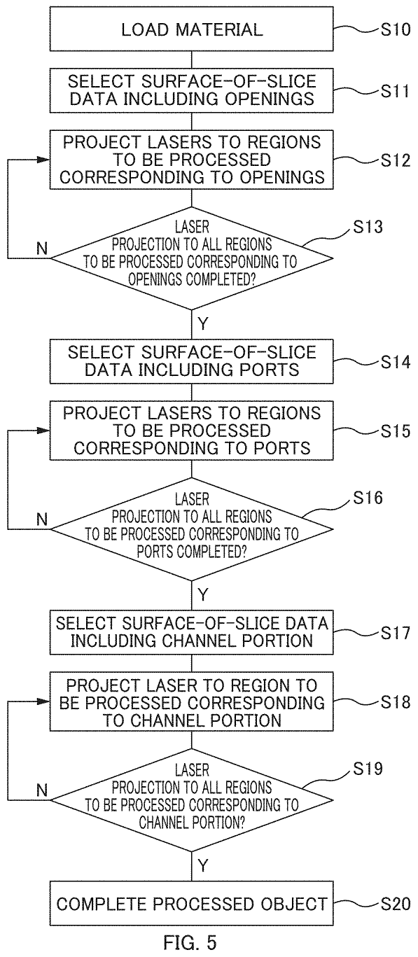

Next, referring to FIG. 5, a specific example of the processing method according to this preferred embodiment is described. In this preferred embodiment, an example in which the material M is processed to form the microfluidic device D shown in FIG. 3A is described.

The processing data for the microfluidic device D is generated in advance by the CAD/CAM system 200. This processing data includes the projection order data, the surface-of-slice data Sd1 to Sd6, and the region-to-be-processed data o1 to o3, p1 to p3, and f1 to f5. It is assumed that the following order is determined for the projection data: (1) the openings O1 to O3, (2) the ports P1 to P3, and (3) the channel portion F (in the direction from the side of the ports P1 and P2 to the side of the port P3).

FIG. 5 is a flowchart showing the processing method according to this preferred embodiment. The processing method is performed by the processing system 100. The processing method has been installed in advance on the processing system 100 as a dedicated processing program.

First, a material M to be used is selected and loaded onto the holder 30 of the processor 1 (load material; S10). The material M preferably has a shape corresponding to the shape data (outer contour) that has been used to generate the processing data, but the material M may have any shape as long as it encompasses at least the microfluidic device D.

The computer 2 causes the processor 1 to process the material M based on the processing data for the microfluidic device D.

First, the computer 2 specifies, based on the projection order data, the openings O1 to O3 to which the laser projection is to be performed first. Then, the computer 2 selects the surface-of-slice data Sd1 and Sd6 including the region-to-be-processed data o1 to o3 corresponding to the specified openings O1 to O3 from a number of surface-of-slice data (select surface-of-slice data including openings; S11).

Next, the computer 2 controls the processor 1 in such a manner that lasers are projected to the regions to be processed corresponding to the openings O1 to O3 in the surface of slice corresponding to the surface-of-slice data selected at S11 (project lasers to regions to be processed corresponding to openings; S12). The computer 2 adjusts the focal position of the laser in such a manner that it comes to the region to be processed. Specifically, the computer 2 adjusts the relative position between the projector 10 and the driver 40 and adjusts the orientation and/or angle of the group of lenses included in the projector 10 and the state of the adjuster 20. The adjustment of the focal position etc. is preferably performed considering the refractive index of the material. After the focal position of the laser coincides with the region to be processed, the computer 2 causes the laser to be projected onto the region to be processed in a predetermined projection pattern.

After the completion of all of the laser projections to the regions to be processed corresponding to the openings O1 to O3 (Y at S13), the computer 2 specifies the ports P1 to P3 that are in communication with the openings O1 to O3 based on the projection order data. The computer 2 selects the surface-of-slice data Sd1 and Sd6 including the region-to-be-processed data p1 to p3 corresponding to the specified ports P1 to P3 from the number of surface-of-slice data (select surface-of-slice data including ports; S14). In this example, the region-to-be-processed data p1, p2, o1, and o2 are included in the same surface-of-slice data Sd1, and the region-to-be-processed data p3 and o3 are included in the same surface-of-slice data Sd6.

The computer 2 controls the processor 1 to project lasers to the regions to be processed corresponding to the ports P1 to P3 in the surfaces of slice corresponding to the surface-of-slice data Sd1 and Sd6 that have been selected at S14 (project lasers to regions to be processed corresponding to ports; S15).

By performing the processing in this manner, the regions to be processed to which the laser is projected are always in communication with the outside of the material through one or more of the openings O1 to O3. Therefore, the material that has been molten or gasified by the ablation is drained to the outside of the material through the openings O1 to O3.

After the completion of all of the laser projections to the regions to be processed corresponding to the ports P1 to P3 (Y at S16), the computer 2 specifies the channel portion F that is in communication with the ports P1 to P3 based on the projection order data. Then, the computer 2 selects the surface-of-slice data Sd2 to Sd5 including the region-to-be-processed data f1 to f5 corresponding to the specified channel portion F from the number of surface-of-slice data (select surface-of-slice data including channel portion; S17).

The computer 2 controls the processor 1 to project lasers to the region to be processed corresponding to the channel portion F in the surfaces of slice corresponding to the surface-of-slice data Sd2 to Sd5 that have been selected at S17 (project laser to region to be processed corresponding to channel portion; S18). To do this, according to the projection order data, the lasers are caused to be projected successively to the regions to be processed in the y-direction from the side of the ports P1 and P2 to the side of the port P3 to form the channel portion F. Accordingly, the computer 2 controls the processor 1 in such a manner that lasers are projected successively from the region to be processed included in the surface of slice corresponding to the surface-of-slice data Sd2 to the region to be processed included in the surface of slice corresponding to the surface-of-slice data Sd5 among the regions to be processed corresponding to the channel portion F.

By performing the processing in this manner, the regions to be processed to which the laser is projected are always in communication with the outside of the material through the port P1 and the opening O1 (or through the port P2 and the opening O2). Therefore, the material that has been molten or gasified by the ablation is drained to the outside of the material through the opening O1 (or the opening O2).

By projecting the lasers to all of the regions to be processed corresponding to the channel portion F (Y at S19), the microfluidic device D in which the openings O1 to O3, the ports P1 to P3 and the hollow space F are formed can be obtained (complete processed object; S20).

It should be noted that, while the above-mentioned example has been described for the order of laser projection in which the laser is projected to the hollow space after the completion of the laser projection to all of the openings O1 to O3, the order is not limiting. Specifically, in the processing method according to this preferred embodiment, it is preferable that the regions to be processed to which the laser is projected are always in communication with the outside of the material through the opening(s). Accordingly, for example, it is possible to use the projection order data defined in the following order: (1) the opening O1, (2) the port P1, (3) the channel portion F, (4) the port P2, (5) the opening O2, (6) the port P3, and (7) the opening O3. When processing is made based on such projection order data, through the opening O1 that is processed first, other regions to be processed are always in communication with the outside of the material.

Alternatively, as in the above-mentioned example, when the regions to be processed corresponding to the openings and the regions to be processed corresponding to the ports are included in the same surface of slice, the laser projections to the regions to be processed corresponding to the openings and the laser projections to the regions to be processed corresponding to the ports may be performed continuously. For example, the lasers are caused to be projected successively from the opening O1 to the region to be processed in the z-direction to form the port P1. In this case, the region to be processed corresponding to the port P1 is always in communication with the outside of the material through the opening O1. Accordingly, the material that has been molten or gasified by the ablation is drained to the outside of the material through the opening O1. Likewise, the computer 2 controls the processor 1 to cause the lasers to be projected successively from the opening O2 to the region to be processed in the z-direction to form the port P2, and to cause the lasers to be projected successively from the processed portion O3 to the region to be processed in the z-direction to form the port P3.

In this way, in the processing method according to this preferred embodiment, ablation is performed to form the hollow space in the material by projecting the lasers from the region to be processed on the surface of the material corresponding to the opening along the regions to be processed corresponding to the hollow space. In this case, the material that has been molten or gasified by the ablation is drained to the outside of the material through the opening that has been processed earlier. Accordingly, the material that has been molten or gasified does not deposit on the hollow space formed by the ablation. That is, the processing method according to this preferred embodiment makes it possible to form processed objects including hollow spaces therein with high precision.

Laser projection for each of the surfaces of slice onto the region to be processed that is extracted for each of the surfaces of slice allows detailed processing. Therefore, even in the cases in which a hollow space has an intricate shape, processed objects can be produced easily.

Furthermore, as the laser projection pattern, the laser can be projected in a projection pattern that lasers are projected to each of different regions in the region to be processed in a certain surface of slice, such that the lasers are projected to each of the different regions at an equal energy density. In this case, processing load on the material due to a fluctuation of the projected energy is able to be reduced. Accordingly, damage of the material attributed to the laser projection is able to be avoided.

Alternatively, the processing method according to this preferred embodiment is able to be achieved by the processing system 100. The processing system 100 is able to control the projector 10 and the driver 40 in such a manner that the ablation is performed to form the hollow space in the material by projecting the lasers from the region to be processed on the surface of the material corresponding to the opening along the regions to be processed corresponding to the hollow space. In this case, the material that has been molten or gasified by the ablation is drained to the outside of the material through the opening that has been processed earlier. Accordingly, the material that has been molten or gasified does not deposit on the hollow space formed by the ablation. That is, the processing system 100 according to this preferred embodiment makes it possible to form processed objects including hollow spaces therein with high precision.

Furthermore, in the processing program according to this preferred embodiment, it is possible to cause the processing system 100 to form the hollow space in the material by performing ablation by causing it to project the lasers from the region to be processed on the surface of the material corresponding to the opening along the regions to be processed corresponding to the hollow space. In this case, the material that has been molten or gasified by the ablation is drained to the outside of the material through the opening that has been processed earlier. Accordingly, the material that has been molten or gasified does not deposit on the hollow space formed by the ablation. That is, by executing the processing program according to this preferred embodiment on the processing system 100, it becomes possible to form processed objects including hollow spaces therein with high precision.

It should be noted that, while the above-mentioned preferred embodiments have been described in terms of the examples in which the hollow spaces are processed in turn from the region to be processed on the surface of the material corresponding to the opening, laser processing that is similar to the above-mentioned preferred embodiments can be performed to materials in which a portion of an opening or a portion of a hollow space is formed.

For example, some microfluidic devices with their openings and ports located at the same positions are different from each other only in the shape of their channel portions. When such microfluidic devices are fabricated, the openings and ports located at fixed positions may be formed in advance by using cutting and only the channel portions may be processed using lasers.

That is, it is possible to form the hollow space in the material by performing ablation to the material in which the opening and a portion of the hollow space in communication with the opening have been formed, by projecting a laser along a region to be processed corresponding to a remaining portion of the hollow space.

Such processing method can be performed by the processing system 100. In one example, the processing method is preferably installed in advance on the processing system 100 as a dedicated processing program. In this case, the controller 2 of the processing system 100 controls the projector 10 and the driver 40 in such a manner that a laser is projected to the material in which an opening and a portion of a hollow space that is in communication with the opening have already been formed, along the region to be processed corresponding to the remainder of the hollow space to perform ablation and form the hollow space in the material.

For example, in the example shown in FIG. 3A, it is assumed that the openings O1 to O3 and the ports P1 to P3 have already been formed. By performing laser processing of such material from the region to be processed corresponding to the channel portion F that is in communication with the ports P1 to P3 in turn, the material that has been molten or gasified by the ablation is drained to the outside of the material through the ports and the openings.

Accordingly, the material that has been molten or gasified does not deposit on the hollow space formed by the ablation. That is, such processing method, processing system, and processing program also make it possible to form processed objects including hollow spaces therein with high precision.

It should be noted that, while the above-mentioned preferred embodiments have been described in terms of the examples in which the region to be processed is processed for each surface of slice, the processing per surface of slice is not necessarily required. For example, when the inner hollow space does not have a complicated shape as in the channel portion F of the microfluidic device D, the hollow space is able to be formed directly by projecting the laser onto the region to be processed in the material based on the projection order data and the region-to-be-processed data, rather than dividing it into surfaces of slice.

For example, in the above-mentioned example, the computer 2 specifies, from the processing data, the regions to be processed corresponding to the openings O1 to O3 on the surface of the material. Next, the computer 2 controls the processor 1 to project the laser to the regions to be processed corresponding to the specified openings O1 to O3.

After the completion of all of the laser projections to the regions to be processed corresponding to the openings O1 to O3, the computer 2 specifies, from the processing data, the regions to be processed corresponding to the hollow spaces (the ports P1 to P3 and the channel portion F) that are in communication with the openings O1 to O3. The computer 2 causes the lasers to be projected successively to the regions to be processed corresponding to the specified hollow spaces from the opening O1 to the region to be processed in the z-direction to form the port P1 based on the projection order data. Likewise, the computer 2 causes the lasers to be projected successively from the opening O2 to the region to be processed in the z-direction to form the port P2, and causes the lasers to be projected successively from the processed portion O3 to the region to be processed in the z-direction to form the port P3.

Thereafter, based on the projection order data, the computer 2 causes the lasers to be projected successively to the regions to be processed in the y-direction from the side of the ports P1 and P2 to the side of the port P3 to form the channel portion F. By projecting the lasers to all of the regions to be processed corresponding to the hollow spaces, the microfluidic device D in which the openings O1 to O3, the ports P1 to P3 and the hollow space F are formed can be obtained.

Processed objects that can be produced using the above-mentioned processing methods are not limited to microfluidic devices. The above-mentioned processing methods can be used widely for producing processed objects including hollow spaces therein.

It is also possible to supply a program to a computer using a non-transitory computer readable medium with an executable program thereon, in which the processing program(s) to perform the processing methods of the above preferred embodiments are stored. Examples of the non-transitory computer readable medium include magnetic storage media (e.g. flexible disks, magnetic tapes, and hard disk drives), and CD-ROMs (read only memories).

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-8. (canceled)

9. A processing method of producing a processed object by processing a material, the processed object including an opening to outside and a hollow space in communication with the opening, the method comprising:
forming the hollow space in the material by performing ablation by projecting a laser from a region to be processed on a surface of the material corresponding to the opening along a region to be processed corresponding to the hollow space.

10. The processing method according to claim 9, wherein
the region to be processed is extracted in each of surfaces of a slice obtained by slicing the material to a certain thickness in a certain direction; and
the laser is projected to each of the surfaces of the slice.

11. The method according to claim 10, wherein the laser is projected in a projection pattern such that lasers are projected with an equal or substantially equal energy density to each of different regions in the region to be processed in one of the surfaces of the slice.

12. A processing method of producing a processed object by processing a material, the processed object including an opening to outside and a hollow space in communication with the opening, the method comprising:
forming the hollow space in the material by performing ablation to the material in which the opening and a portion of the hollow space in communication with the opening have been formed, by projecting a laser along a region to be processed corresponding to a remaining portion of the hollow space.

13. The processing method according to claim 12, wherein
the region to be processed is extracted in each of surfaces of a slice obtained by slicing the material to a certain thickness in a certain direction; and
the laser is projected to each of the surfaces of the slice.

14. The method according to claim 13, wherein the laser is projected in a projection pattern such that lasers are projected with an equal or substantially equal energy density to each of different regions in the region to be processed in one of the surfaces of the slice.

15. A processing system with which a processed object is produced by processing a material, the processed object including an opening to outside and a hollow space with a predetermined shape and in communication with the opening, the system comprising:
a projector that projects a laser;
a holder that holds the material;
a driver that moves the projector and the holder relative to each other; and
a controller that controls the projector and the driver in such a manner that the hollow space is formed in the material by performing ablation by projecting a laser from a region to be processed on a surface of the material corresponding to the opening along a region to be processed corresponding to the hollow space.

16. A processing system with which a processed object is produced by processing a material, the processed object including an opening open to outside and a hollow space with a predetermined shape and in communication with the opening, the system comprising:
a projector that projects a laser;
a holder that holds the material;
a driver that moves the projector and the holder relative to each other; and
a controller that controls the projector and the driver in such a manner that the hollow space is formed in the material by performing ablation to the material in which the opening and a portion of the hollow space in communication with the opening have been formed, by projecting a laser along a region to be processed corresponding to a remaining portion of the hollow space.
